(19) United States
(12) Patent Application Publication
(10) Pub. No.: US 2014/0283970 A1
(43) Pub. Date: Sep. 25, 2014

(54) LARGE-AREA FILMS USING INTERFACIAL SELF-ASSEMBLY OF MICROPARTICLES AND METHOD OF MANUFACTURING THE SAME

(71) Applicant: KOREA ADVANCED INSTITUTE OF SCIENCE AND TECHNOLOGY, Daejeon (KR)

(72) Inventors: Sang Ouk Kim, Daejeon (KR); Jong Won Shim, Seongnam-si (KR)

(73) Assignee: KOREA ADVANCED INSTITUTE OF SCIENCE AND TECHNOLOGY, Daejeon (KR)

(21) Appl. No.: 14/187,242

(22) Filed: Feb. 22, 2014

(30) Foreign Application Priority Data
Feb. 25, 2013 (KR) 10-2013-0020127

(51) Int. Cl. C01B 31/04

(52) U.S. Cl. CPC C01B 31/0446; C01B 31/043
USPC 156/60; 423/448; 423/415.1

(57) ABSTRACT

The present invention provides a method for manufacturing a large-area film, the method comprising the steps of: dispersing various fine particles in a polar solvent to prepare a dispersion; adding water to the dispersion to prepare a mixture; and adding an organic solvent capable of generating Rayleigh-Benard convection to the mixture to induce the interfacial assembly of the fine particles, thereby forming the film. The invention also provides a large-area film manufactured by the method. According to the invention, a large-area, high-purity film can be quickly manufactured by a simple solution process, and the manufactured large-area film has excellent physical and electrical properties, and thus can be used in various applications.

### TECHNICAL FIELD

The present invention relates to a large-area film formed by the interfacial self-assembly of fine particles and a manufacture method thereof, and more particularly, to a method of manufacturing a large-area film in a very quick manner by adding an organic solvent capable of generating Rayleigh-Benard convection to a water/polar organic solvent mixture containing fine particles dispersed therein and to a large-area film manufactured thereby.

### BACKGROUND ART

Graphene is a two-dimensional material consisting of carbon atoms arranged in a hexagonal honeycomb pattern and is known to have excellent physical strength and thermal conductivity and show a maximum electron mobility of 200,000 cm²/Vs at room temperature. The use of this high electron mobility of graphene makes it possible to observe the half-integer quantum hall effect even at a low magnetic field and room temperature. In recent years, due to such excellent properties of graphene, there have been a number of attempts to apply graphene to transparent electrodes, flexible displays and the like.

Graphene films are generally synthesized by chemical vapor deposition using metal catalysts. A method of manufacturing a large-area graphene film by chemical vapor deposition was disclosed (Kim et al., Nature, 457, 706:2009), but the process that is carried out at high temperature (about 1000° C.) in a vacuum has disadvantages in that it is expensive and requires a long batch time.

Meanwhile, high-purity graphene has a limited solubility in a solvent, and thus a simple solution process of high-purity graphene was generally considered impossible. As a substitute for high-purity graphene, chemically modified graphene such as graphene oxide was used as a cost-effective precursor in the solution process (Korean Patent Laid-Open Publication No. 10-2010-0136576). However, due to deterioration in the properties of graphene during the chemical modification of graphene, significant technical problems arise in the practical application of graphene.

Accordingly, the present inventors have made extensive efforts to solve the above-described problems, and as a result, have found that, when an organic solvent capable of generating Rayleigh-Benard convection is added to a water/polar organic solvent mixture containing fine particles dispersed therein, a large-area film is quickly formed by the interfacial assembly of the fine particles, thereby completing the present invention.

### DISCLOSURE OF INVENTION

It is an object of the present invention to provide a method of quickly manufacturing a large-area film from fine particles by a simple solution process.

Another object of the present invention is to provide a large-area film manufactured by the above manufacture method.

To achieve the above objects, the present invention provides a method for manufacturing a large-area film, the method comprising the steps of: (a) preparing a dispersion by dispersing fine particles in a polar organic solvent; (b) preparing a mixture by adding water to the dispersion; and (c) inducing an interfacial assembly of the fine particles by adding an organic solvent capable of generating Rayleigh-Benard convection to the mixture, thereby forming the film.

The present invention also provides a large-area film manufactured by the above method.

The present invention also provides a method for manufacturing a large-area graphene film, the method comprising the steps of: (a) preparing a dispersion by dispersing graphene in N-methyl-2-pyrrolidone (NMP); (b) preparing a mixture by adding water to the dispersion; and (c) inducing an interfacial assembly of the graphene by adding ethyl acetate (EA) to the mixture, thereby forming the film.

The present invention also provides a large-area graphene film manufactured by the above method.

The present invention also provides a method for manufacturing a large-area graphene oxide film, the method comprising the steps of: (a) preparing a dispersion by dispersing graphene oxide in a polar organic solvent; (b) preparing a mixture by adding water to the dispersion; and (c) inducing the interfacial assembly of the graphene oxide by adding strong acid to the mixture, followed by addition of ethyl acetate (EA), thereby forming the film.

The present invention also provides a large-area graphene oxide film manufactured by the above method.

### BRIEF DESCRIPTION OF THE DRAWINGS

FIG. 1a is a still photograph showing a graphene film assembly process according to the present invention; FIG. 1b shows the results of observing the vertical movement of graphene nano-platelets in the bottom of solution by the Rayleigh-Benard convection induced by the addition of ethyl acetate (EA); and FIG. 1c shows the water solubilities, vapor pressures and interfacial tensions of various solvents.

FIG. 2a schematically shows the horizontal movement of graphene nano-platelets; FIG. 2b is an infrared camera photograph showing that interfacial tension that is changed by the evaporation of a solvent added is consistent with the assembly position of a film; FIG. 2c shows a process in which graphene nano-platelets are disassembled and reassembled; and FIG. 2d shows the surface charge states of nanostructures at various pHs and EA concentrations (: graphene, ▴: graphene oxide, and ▪: HOPG).

FIG. 3a shows a chamber for controlling the evaporation of ethyl acetate (EA); FIG.

3b is an AFM photograph showing the state of the surface pores of a film manufactured according to the present invention; FIG. 3c shows sheet resistance as a function of the evaporation rate of EA; and FIG. 3d shows the image of pores in the film as a function of film manufacture conditions.

FIGS. 4a, 4b and 4c show TEM photographs of films made from SWCNTs, MWCNTs and fullerene, respectively; and FIGS. 4d, 4e and 4f show the inventive graphene films transferred onto a glass wafer, a PDMS film and a PET film, respectively.

### BEST MODE FOR CARRYING OUT THE INVENTION

Unless defined otherwise, all technical and scientific terms used herein have the same meaning as commonly understood by one of ordinary skill in the art to which the invention pertains. Generally, the nomenclature used herein and the experiment methods are those well known and commonly employed in the art.

In the present invention, it was found that, when an organic solvent capable of generating Rayleigh-Benard convection is added to a water/organic solvent mixture containing fine particles dispersed therein, a large-area uniform film can be quickly manufactured.

Thus, in one aspect, the present invention is directed to a method for manufacturing a large-area film, the method comprising the steps of: (a) preparing a dispersion by dispersing fine particles in a polar organic solvent; (b) preparing a mixture by adding water to the dispersion; and (c) inducing an interfacial assembly of the fine particles by adding an organic solvent capable of generating Rayleigh-Benard convection to the mixture, thereby forming the film.

In the present invention, the fine particles are nano- or micro-sized particles that can be dispersed alone or together with a polar organic solvent. Preferably, the fine particles may include organic nanostructures, inorganic nanostructures or metal nanostructures.

The organic nanostructures may be composed of graphene, graphene oxide, silicone, single-wall carbon nanotubes (SWCNTs), multi-wall carbon nanotubes (MWCNTs), nanofibers, or fullerene. The inorganic nanostructures may be composed of silica, titanium oxide, zinc oxide, molybdenum disulfide, manganese, or zirconia. The metal nanostructures may be composed of gold, silver, platinum, iron oxide, copper oxide, or cobalt oxide.

The polar organic solvent that is used in step (a) of the method of the present invention may be any one or more selected from the group consisting of N-methyl-2-pyrrolidone (NMP), dimethylacetamide, dimethylformamide (DMF), ethanol, and methanol. Preferably, the polar organic solvent may be N-methyl-2-pyrrolidone (NMP).

In order to facilitate the dispersion of fine particles in an organic solvent, the fine particles are preferably dispersed by sonication.

Water is added to the dispersion to prepare a water/organic solvent mixture, and then ethyl acetate (EA) is added to the mixture to induce the interfacial assembly of the fine particles, thereby forming a film. If hydrophobic fine particles are allowed to stand in the aqueous solution for a long period of time, the fine particles can aggregate and precipitate. For this reason, ethyl acetate is preferably added before the fine particles precipitate.

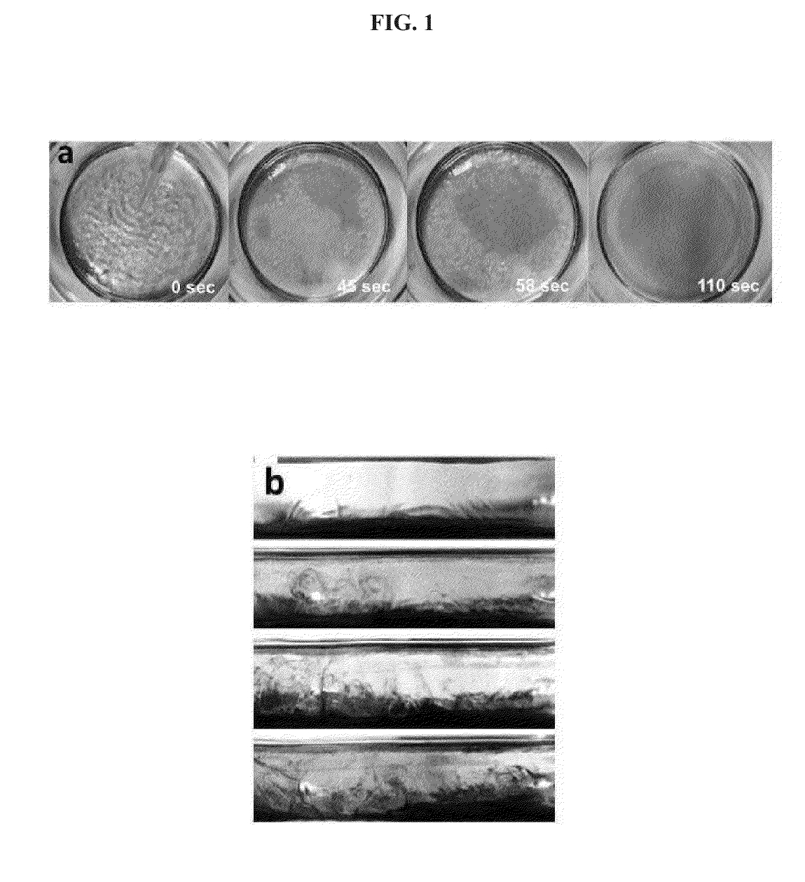

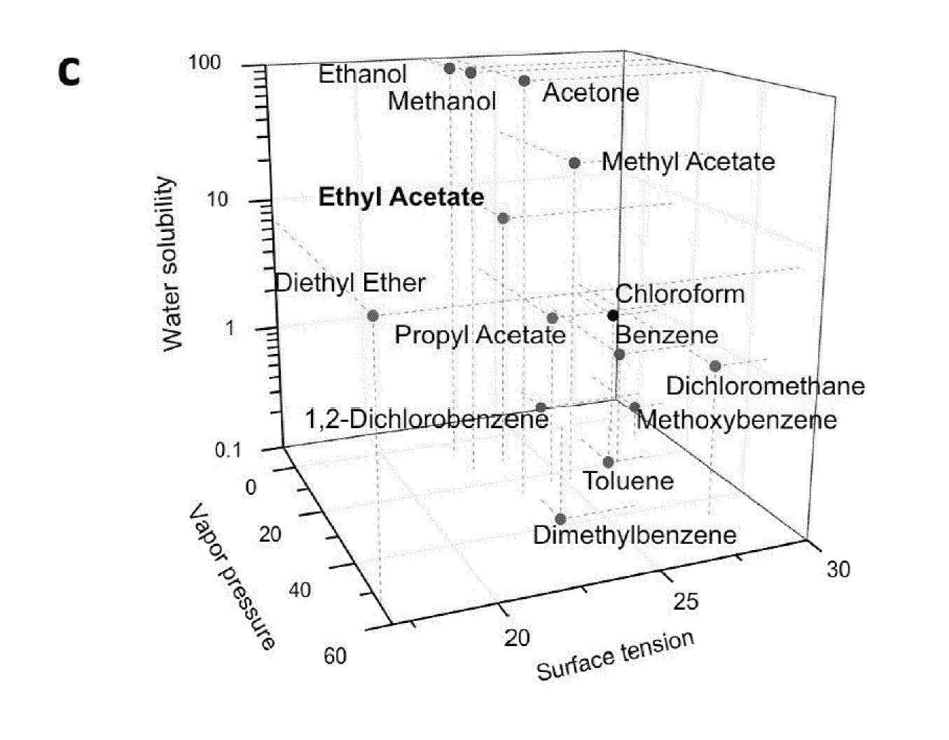

The organic solvent that is added to the mixture in step (c) of the method of the present invention has suitable water solubility, high vapor pressure and low interfacial tension values as shown in FIG. 1c, and thus can induce the Rayleigh-Benard convection to move fine particles to the aqueous phase interface. Preferably, the organic solvent that is used in step (c) may be any one or more selected from the group consisting of ethyl acetate, diethylether, dichloromethane, chloroform, propyl acetate, methyl acetate, dichlorobenzene, and dimethylbenzene. More preferably, it may be ethyl acetate.

Moreover, the size and distribution of nano-pores in the large-area film and the thickness of the film can be changed by controlling the evaporation rate of the organic solvent in step (c). In the self-assembly method of the present invention, the aggregation and interfacial assembly of fine particles including graphene in the solution competitively occur, and when the transverse assembly of fine particles at the water-air interface becomes slower, the aggregation of particles in water will relatively increase. Thus, the slow assembly speed of particles enables the production of a relatively thick film. Due to this slow transverse movement speed, the film includes a plurality of large nano-pores.

However, induction of quick surface assembly makes it possible to manufacture a thinner film having a sense structure, which has little or no pores. If a thick film having a non-porous dense structure is to be manufactured, a thick film having large nano-pores is first manufactured, and then the rapid evaporation of the solvent from the film floating on water is transiently induced so that pores can be additionally removed from the film by a capillary force.

When a film is to be manufactured from electrically conductive nanoparticles including graphene, controlling the thickness and pore size of the film by the above-described method is very important in controlling the transparency and electrical conductivity of the film. In order to manufacture a film having increased electrical conductivity, it is general to manufacture a thick film having reduced resistance, but in this case, the film has low light transmittance leading to low transparency, which impedes the application of the film to a transparent electrode. However, the film according to the present invention has an advantage in that the transparency of the film can be maintained by an increased number of nano-pores even when the film is thick.

The large-area film manufactured according to the present invention is transferred onto a substrate by a known process, and the substrate may be made of a material selected from the group consisting of silicone, a silicon wafer, glass, a polymer film, and mixtures thereof.

The polymer film may be a film based on polyester, polycarbonate, polyethersulfone or acryl resin. More specifically, the polymer film may be made of polyethylene terephthalate (PET), polyethylene naphthalate (PEN) or polyethersulfone (PES).

In accordance with an embodiment of the present invention, graphite powder is dispersed in N-methyl-2-pyrrolidone (NMP) by sonication to prepare a dispersion. The graphene dispersion is mixed with deionized water so that it is transiently stabilized due to solvation of the graphene by the NMP molecule. However, if the dispersion is maintained for a long period of time, the NMP molecules surrounding the graphene nanoparticles will be desorbed by the water molecules to induce the hydrophobic aggregation of the exposed graphene nano-platelets, and thus the graphene nano-platelets will precipitate to the bottom of the cell. Thus, when ethyl acetate (EA) is added to the dispersion before destabilization of the dispersion occurs, the graphene nano-platelets will spontaneously move to the surface of the aqueous phase, whereby a uniform film will be manufactured.

Spontaneous movement of the graphene nano-platelets toward the liquid interface is attributable to the Rayleigh-Benard convection induced by the evaporation and cooling of the EA layer. Ethyl acetate (EA), a polar solvent, is partially dissolved in water (6-8% v/v). When an excessive amount (about 10% v/v) of EA is added to the mixture, a thin liquid layer is formed on the surface of the water-soluble medium. Then, the difference in temperature between the top of the EA layer and the bottom of the water-soluble medium, induced by the rapid evaporation of volatile EA, induces convection due to Rayleigh-Benard instability. In the present invention, the difference in temperature (ΔTₕ) measured by IR imaging is about 2° C., and the depth (h) of the aqueous phase is 20 mm. The Rayleigh number (R_{α}) can be calculated using the following equation 1.

$${R}_{a} = \frac{g α Δ {T}_{h}}{η κ} {h}^{3} \qquad Equation 1$$

wherein g is gravity acceleration, a is thermal expansion coefficient, η is dynamic viscosity, and κ is thermal diffusivity. When ΔTₕ=2° C., h=20 mm, α=6.9×10⁻⁵ C⁻¹, η=0.001 Pa·s and κ=3.34×10⁻¹⁰ m²s are substituted into equation 1, a Rayleigh number (R_{α}) of 7.5×10⁴ that exceeds a critical value of 1100.65 can be calculated. This convection flow raises the graphene from the bottom of the cell to the water/EA interface (FIG. 1b). This indicates that the high vapor pressure of EA is an important factor in moving graphene to the water/EA interface. Among various organic solvents, only organic solvents having properties equal or similar to those of EA and DEE can make a strong convection flow in atmospheric conditions (see FIG. 1c).

In addition, for the ultra-high-speed assembly of graphene, the interfacial assembly of graphene nano-platelets on the water interface should occur. If an aqueous phase not mixed or partially mixed with surface-active materials loses equilibrium partitioning, interfacial instabilities can occur. Such instabilities can be activated by a chemical reaction at the interface, evaporation or expansion/compression, resulting in Marangoni forces.

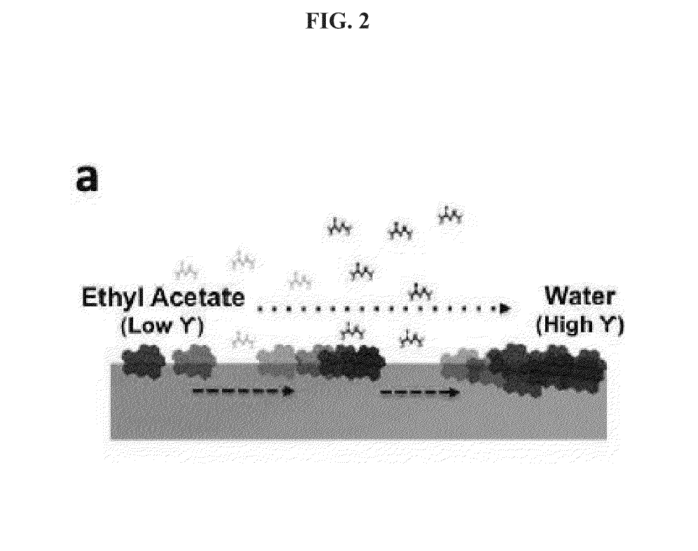

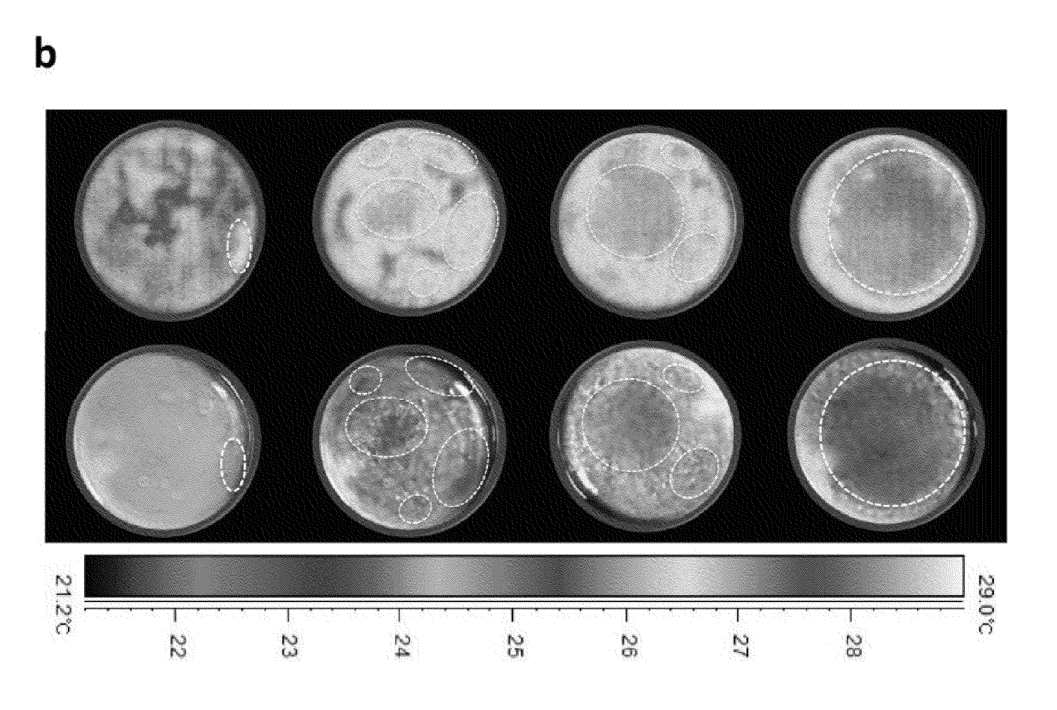

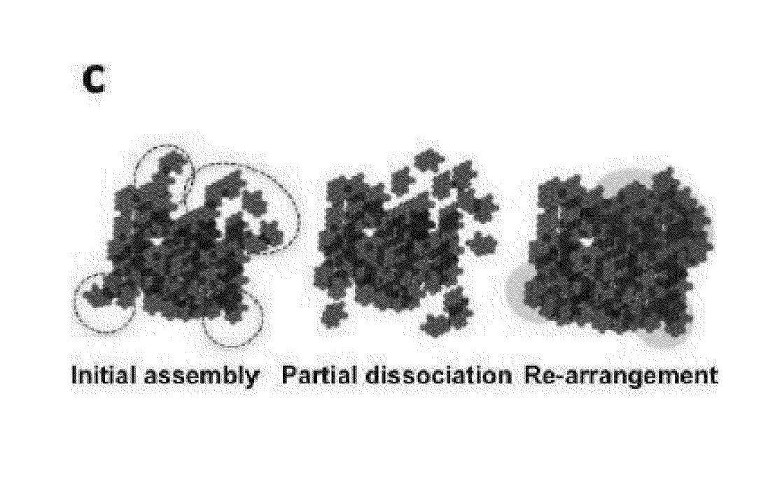

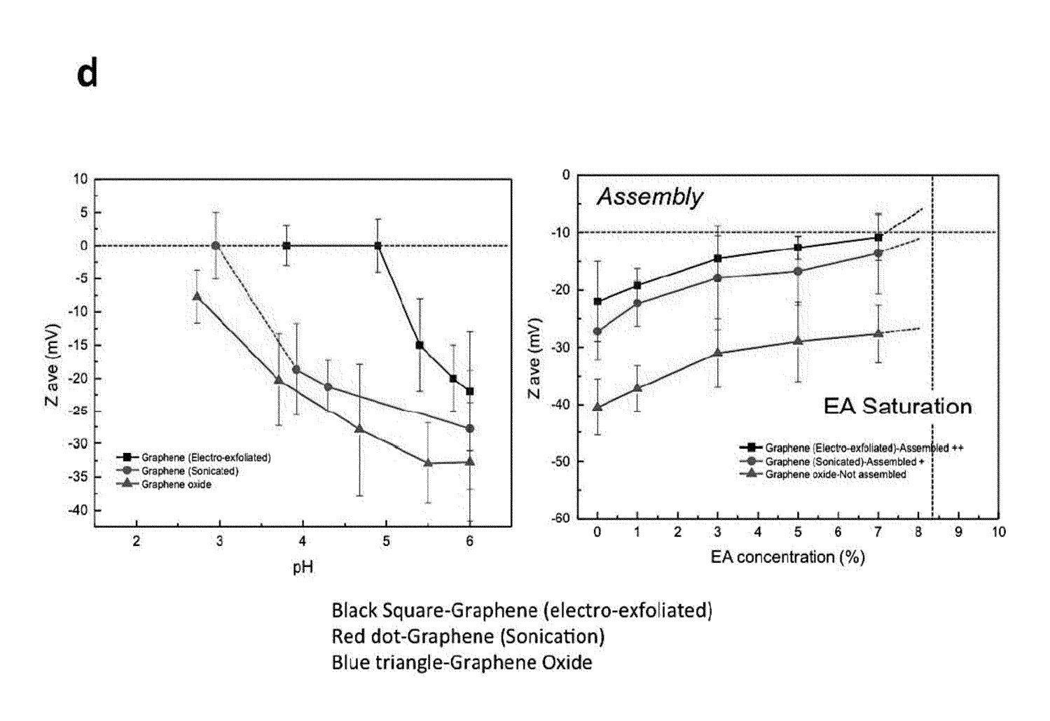

As highly volatile EA evaporates, the concentration of EA on the liquid surface becomes non-uniform. This causes a difference in surface tension, and graphene nano-platelets on the liquid surface move from a low-surface-tension region (EA-rich) to a high-surface-tension region (water-rich) (see FIG. 2a). FIG. 2b is an IR image showing non-uniform concentration caused by the evaporation of EA. The nano-platelets that moved by Marangoni forces collide and overlap with each other and are ultimately fixed by strong 7E-7E interactions. In the interfacial assembly process, graphene seeds or flakes are continuously agitated by surface tension. Weakly bonded flakes are disassembled and reassembled until they are sufficiently strongly bonded so that they can resist instability (see FIG. 2c). Importantly, after graphene moved to the liquid surface, the interfacial assembly thereof does not continuously occur, but simultaneously occurs. The assembly of graphene is continued until EA on the surface is completely evaporated or graphene nanoparticles dispersed in water are completely consumed.

Thus, in another aspect, the present invention is directed to a method for manufacturing a large-area graphene film, the method comprising the steps of: (a) (a) preparing a dispersion by dispersing graphene in N-methyl-2-pyrrolidone (NMP); (b) preparing a mixture by adding water to the dispersion; and (c) inducing an interfacial assembly of the graphene by adding ethyl acetate (EA) to the mixture, thereby forming the film, and a large-area graphene film manufactured by the above method.

Also, in still another aspect, the present invention is directed to a method for manufacturing a large-area graphene oxide film, the method comprising the steps of: (a) preparing a dispersion by dispersing graphene in N-methyl-2-pyrrolidone (NMP); (b) preparing a mixture by adding water to the dispersion; and (c) inducing an interfacial assembly of the graphene by adding ethyl acetate (EA) to the mixture, thereby forming the film, and a large-area graphene oxide film manufactured by the above method.

### EXAMPLES

Hereinafter, the present invention will be described in further detail with reference to examples. It will be obvious to a person having ordinary skill in the art that these examples are illustrative purposes only and are not to be construed to limit the scope of the present invention.

### Example 1

### Manufacture of Graphene Film

A dispersion of high-purity graphene nano-platelets was prepared by exfoliating graphite powder (Sigma-Aldrich) in N-methyl-2-pyrrolidone (NMP) in a sonication bath for 2 weeks. After sonication, large pieces of graphite were removed by performing centrifugation three times at 5,000 rpm, 8,000 rpm and 10,000 rpm.

For the interfacial assembly of the graphene nano-platelets, ethyl acetate (EA) was added to an NMP-water-graphene mixture. 40 ml of water and 4 ml of ethyl acetate were mixed with 1 ml of the graphene colloid in NMP (0.05 wt %). Evaporation of the volatile EA solvent was performed under atmospheric conditions. As a result, the assembly of graphene was completed in a circular range having a diameter of 10 cm within 2 minutes after addition of ethyl acetate (see FIG. 1a).

The graphene film floating in the aqueous phase was transferred onto a glass or silicon wafer and dried at 195° C. for 2 hours to remove the remaining solvent.

### Example 2

### Manufacture of Graphene Oxide Film

A dispersion of graphene oxide was prepared by a modified Hummers method. Graphene oxide was washed with 10-fold-diluted hydrogen chloride (37%, Sigma-Aldrich) and then dried at room temperature under a vacuum. To remove the remaining impurities, the dried brown powder was dispersed again in deionized water by dialysis (membrane MWCO: 8000). The dialysis was performed for 2 weeks.

To manufacture a film from graphene oxide, a suitable amount of strong acid (30% v/v, H₂SO₄) was added to water, and then graphene oxide mixed with a polar organic solvent was added thereto. Then, ethyl acetate or ethyl ether was added to the surface to induce the interfacial assembly of the graphene oxide to thereby form a film. The formed film was transferred onto a glass, quartz or polymer film and was attached thereto by removing the solvent at high temperature.

FIG. 2d shows the surface charge states of graphene (red ) of the present invention, graphene oxide (blue ▴), and graphene (black ▪) obtained by electrochemical exfoliation, at various EA concentrations and pHs. Unlike the graphene of the present invention and the graphene obtained by electrochemical exfoliation, the graphene oxide was not reduced due to the degree of initial oxidation thereof when EA alone was added thereto, but it was reduced when a sufficient amount of strong acid (30% v/v, H₂SO₄) was added thereto before addition of EA.

### Example 3

### Control of Transparency and Electrical Conductivity of Electrically Conductive Film

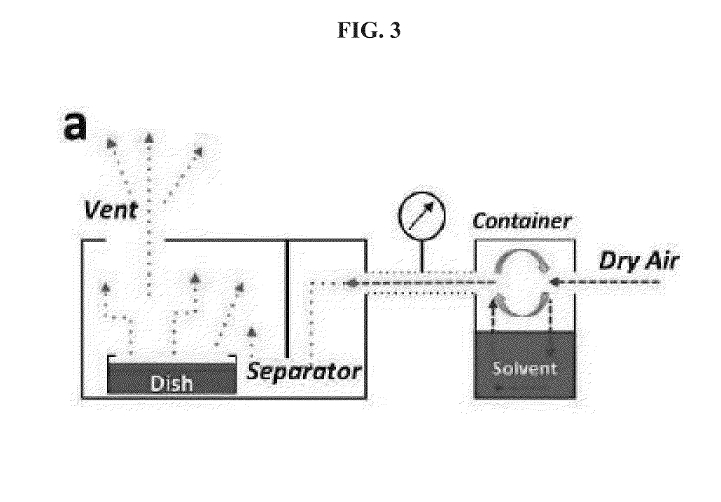

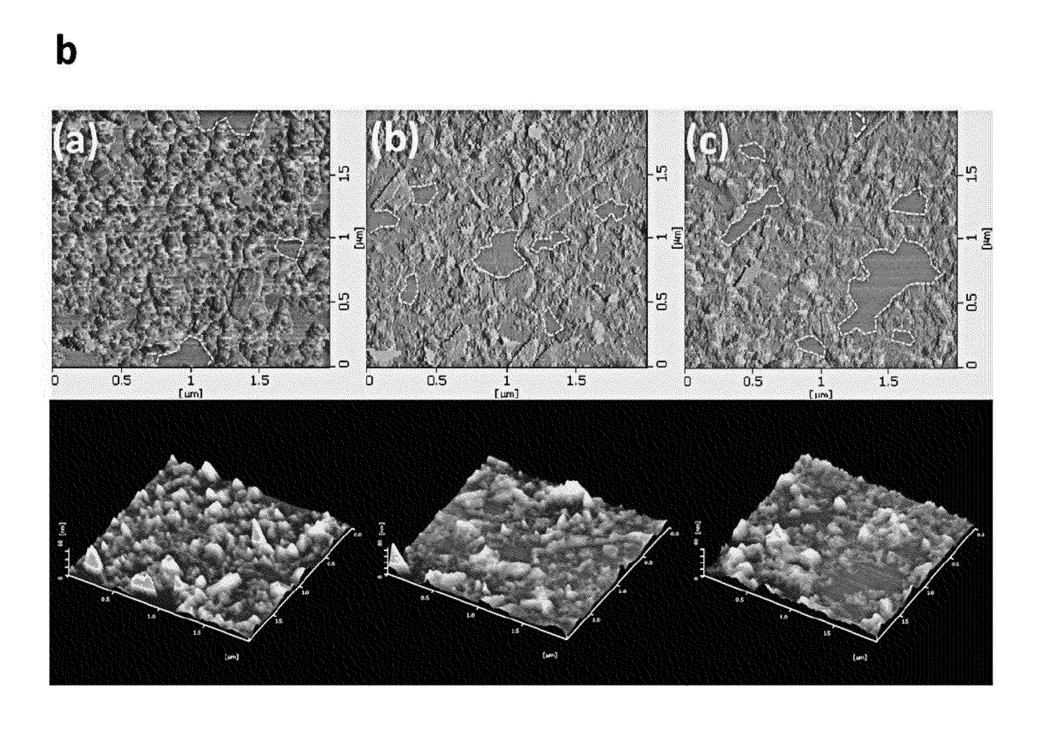

As shown in FIG. 3a, the evaporation rate of an organic solvent added to the surface of a water-nanoparticle dispersion was controlled using a semi-closed chamber. As a result, it was shown that, as the evaporation rate of the organic solvent became slower, the resulting film became thicker and the size of nano-pores in the film relatively increased (see FIG. 3b). Further, as the electrically conductive film became thicker, the sheet resistance of the film was lowered (see FIG. 3c). In addition, it could be seen that relatively large nano-pores in the thicker film could be removed by a very simple additional process, thereby providing a film having a dense structure (see FIG. 3d).

### Example 4

### Manufacture of Various Organic Nanostructure Films

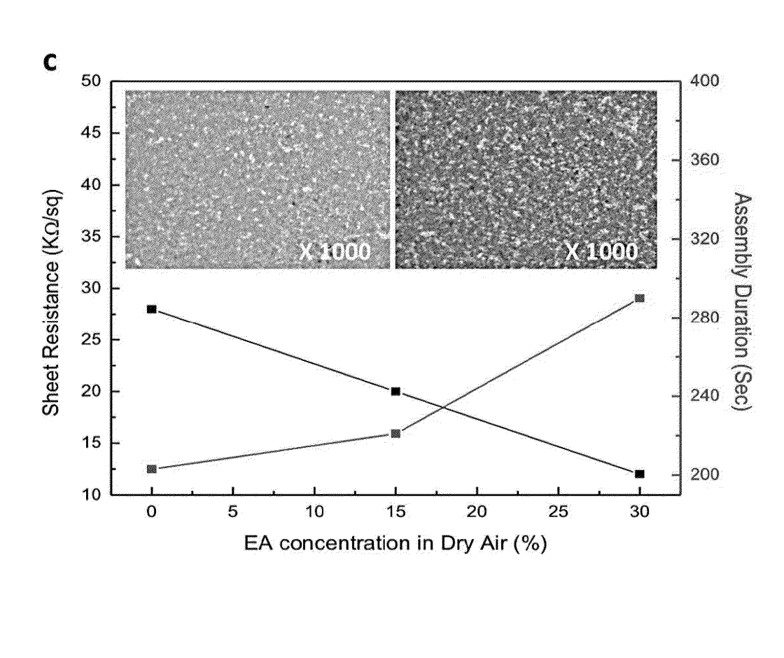

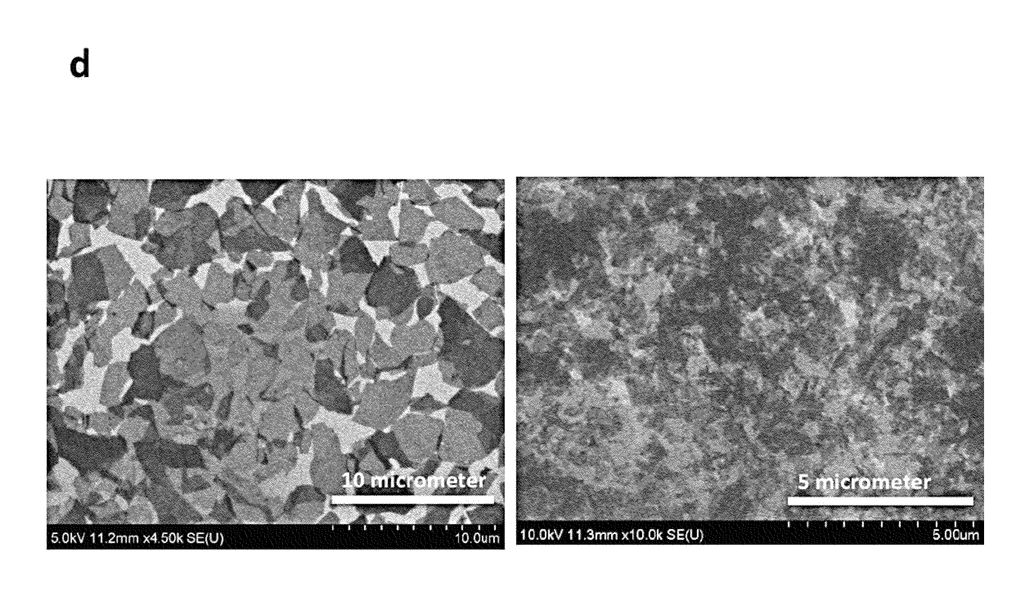

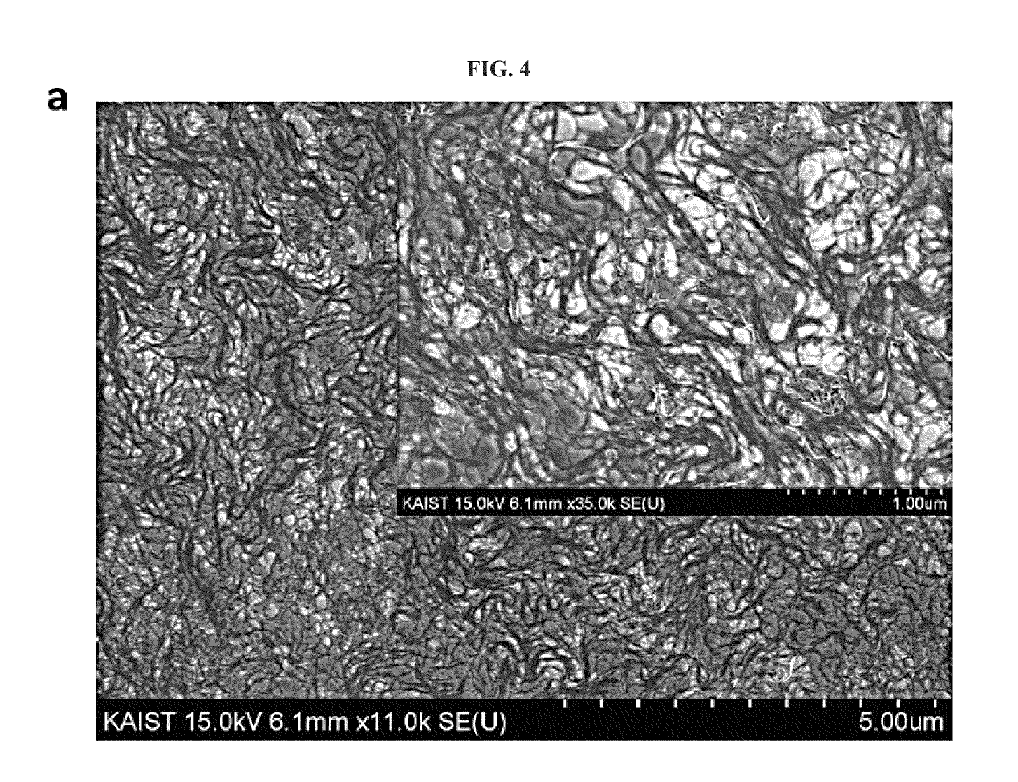

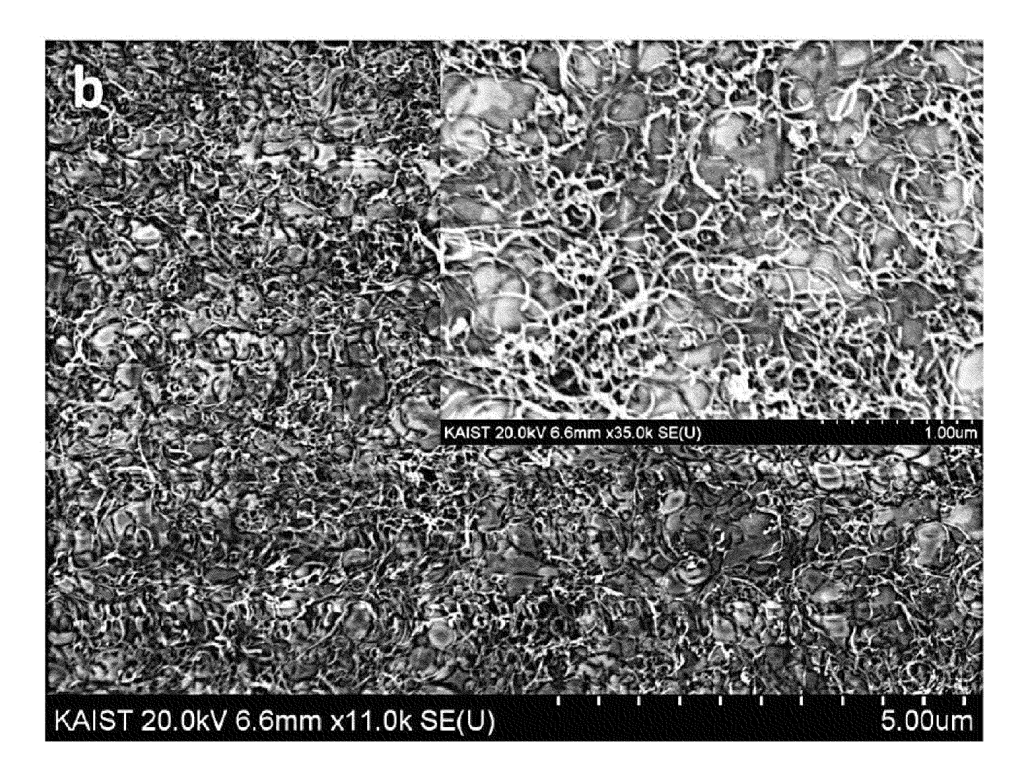

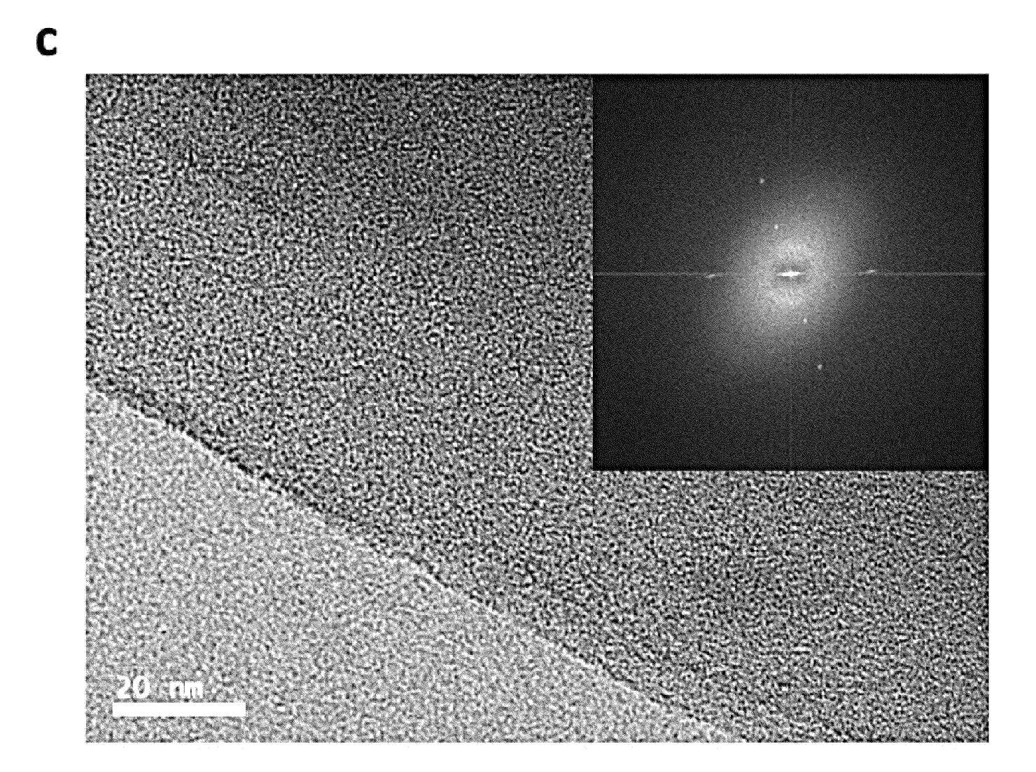

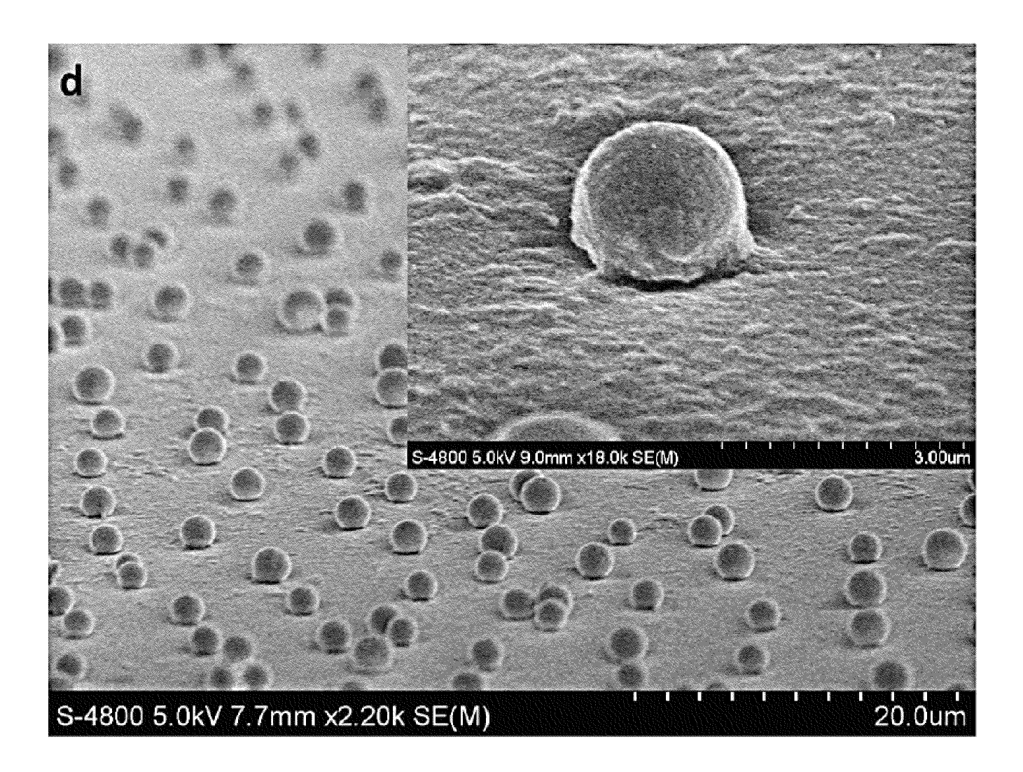

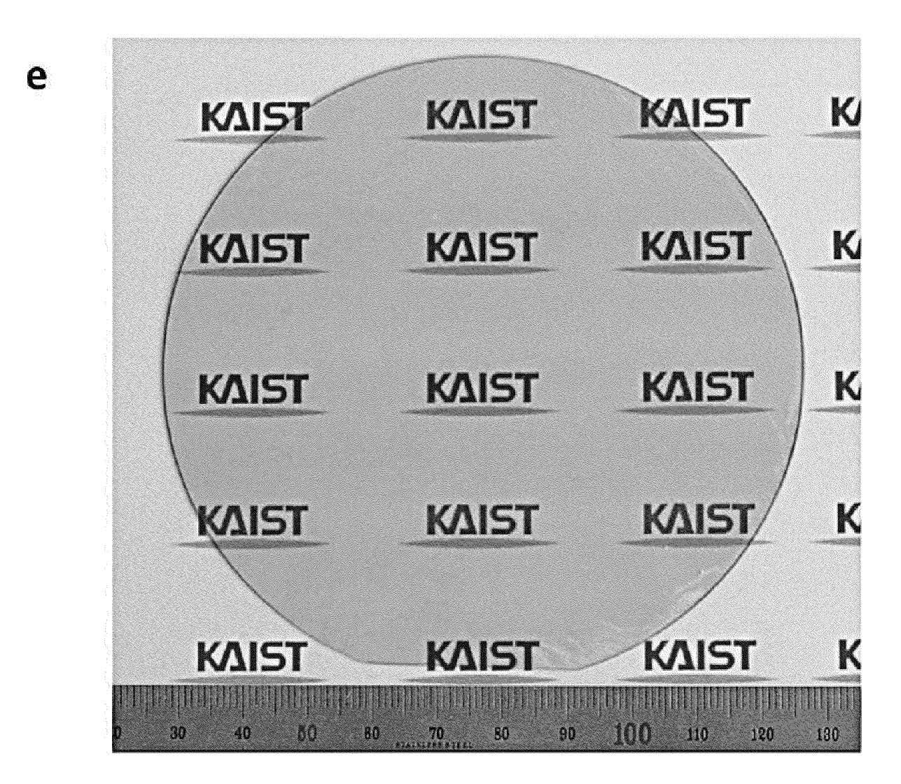

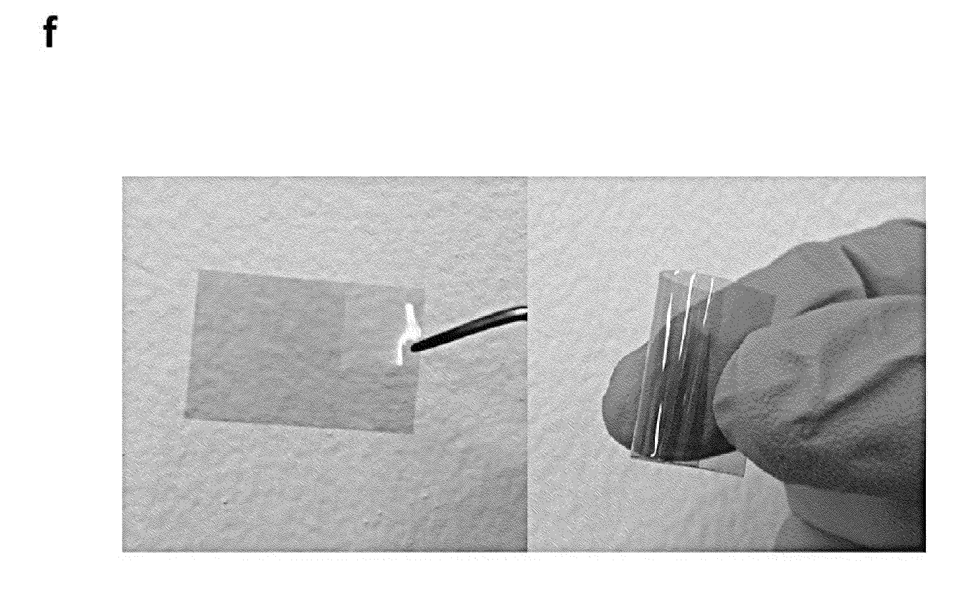

In the same manner as described in Example 1, films were manufactured from SWCNTs, MWCNTs and fullerene, respectively. FIGS. 4a and 4b are electron scanning microscope (ESM) photographs showing films made from SWCNTs and MWCNTs, respectively. Fullerene was also formed into a two-dimensional array film (see FIG. 4c).

Films floating on the liquid surface can be immediately transferred onto various substrates. As shown in FIG. 4d, a large-area film was transferred onto a glass wafer having a diameter of 4 inches. Further, as shown in FIG. 4e, it was shown that a graphene film could be transferred onto a flexible polymer (PDMS) substrate. After transfer, the remaining water and NMP were removed by drying the film at 195° C. for 30 minutes. In addition, it was found that the graphene film could be used to coat a silicon bead and a PET film (see FIG. 4f).

### Comparative Example 1

### Addition of Diethyl Ether (DEE)

An experiment was performed in the same manner as described in Example 1, except that diethyl ether (DEE) was used in place of EA as the solvent. As a result, graphene nano-platelets moved toward the liquid surface, but no interfacial assembly was observed.

This appears to be attributable to the difference in acidity between EA and DEE. The edge of graphene nano-platelets made from natural graphite is composed of acidic functional groups such as carboxylic acid. Acidic ethyl acetate (EA) inhibits the dehydrogenation of carboxyl groups, but when neutral DEE is used, carboxyl groups are dehydrogenated. As a result, unlike the case in which EA is added, the edge of graphene nano-platelets floating on a medium to which DEE was added is negatively charged. In other words, it appears that electrostatic repulsion induced by the negatively charged edge impeded the interfacial assembly of graphene nano-platelets.

### Comparative Example 2

### Addition of Dichloromethane

An experiment was performed in the same manner as described in Example 1, except that dichloromethane was used in place of EA as the solvent. As a result, dichloromethane did not spread on water by surface tension and was suspended as drops, and effective Rayleigh-Benard turbulence did not occur in spite of the low vapor pressure of the solvent, and thus the movement of graphene to the surface became very slow. Consequently, fragments of a thick film were produced, but the time taken for production of the film was very long (1 hour or longer) compared to the assembly time of the present invention (2 minutes), and it was impossible to effectively control the thickness and pore size of the film.

Although the present invention has been described in detail with reference to the specific features, it will be apparent to those skilled in the art that this description is only for a preferred embodiment and does not limit the scope of the present invention. Thus, the substantial scope of the present invention will be defined by the appended claims and equivalents thereof.

### INDUSTRIAL APPLICABILITY

According to the inventive method for manufacturing large-area films, large-area, high-purity films having various thicknesses can be quickly manufactured by a simple solution process. Further, the size and distribution of nano-pores in the film can be controlled by changing the manufacture conditions, and thus it is possible to control both the light transmittance and electrical conductivity of the film. In addition, unlike the case of chemically modified graphene oxide, it is possible to manufacture a graphene film having excellent properties. Thus, the film manufactured according to the present invention can be advantageously used in various applications, including transparent films, electrically conductive thin films, heating elements, flexible display devices, organic LEDs, etc.

1. A method for manufacturing a large-area film, comprising the steps of:
(a) preparing a dispersion by dispersing fine particles in a polar solvent;
(b) preparing a mixture by adding the dispersion to water; and
(c) inducing an interfacial assembly of the fine particles by adding a volatile organic solvent capable of generating Rayleigh-Benard convection and Marangoni effect simultaneously to the mixture, thereby forming the film.

2. The method of claim 1, wherein the fine particles are selected from the group consisting of organic nanostructures, inorganic nanostructures, and metal nanostructures.

3. The method of claim 2, wherein the organic nanostructures are selected from the group consisting of graphene, graphene oxide, silicone, single-wall carbon nanotubes (SWCNTs), multi-wall carbon nanotubes (MWCNTs), nanofibers, and fullerene.

4. The method of claim 2, wherein the inorganic nanostructures are selected from the group consisting of silica, titanium oxide, zinc oxide, molybdenum disulfide, manganese, and zirconia.

5. The method of claim 2, wherein the metal nanostructures are selected from the group consisting of gold, silver, platinum, iron oxide, copper oxide, and cobalt oxide.

6. The method of claim 1, wherein the polar solvent in the step (a) is any one or more selected from the group consisting of N-methyl-2-pyrrolidone (NMP), dimethylacetamide, dimethylformamide (DMF), ethanol, methanol, and water.

7. The method of claim 1, wherein the organic solvent in the step (c) is selected from the group consisting of ethyl acetate (EA), diethylether, dichloromethane, chloroform, propyl acetate, methyl acetate, dichlorobenzene, and dimethylbenzene.

8. The method of claim 1, wherein the organic solvent in step (c) is added before the fine particles precipitate.

9. The method of claim 1, wherein the thickness and the pore structure of the film are controlled by the evaporation rate of the organic solvent in step (c).

10.-12. (canceled)

13. A large-area film manufactured by the method of claim 1.

14. A method for manufacturing a large-area graphene film comprising the steps of:
(a) preparing a dispersion by dispersing graphene in N-methyl-2-pyrrolidone (NMP) and dimethylformamide (DMF);
(b) preparing a mixture by adding water to the dispersion; and
(c) inducing an interfacial assembly of the graphene by adding ethyl acetate (EA) to the mixture, thereby forming the film.

15. The method of claim 14, wherein the ethyl acetate in the step (c) is added before graphene precipitates.

16.-18. (canceled)

19. A large-area graphene film manufactured by the method of claim 14.

20. A method for manufacturing a large-area graphene oxide film comprising the steps of:
(a) preparing a dispersion by dispersing graphene oxide in a polar solvent;
(b) preparing a mixture by adding water to the dispersion; and
(c) inducing the interfacial assembly of the graphene oxide by adding strong acid to the mixture, followed by addition of ethyl acetate (EA) or diethyl ether, thereby forming the film.

21. The method of claim 20, wherein the polar solvent in the step (a) is any one or more selected from the group consisting of N-methyl-2-pyrrolidone (NMP), dimethylacetamide, dimethylformamide (DMF), ethanol, methanol, and water.

22. The method of claim 20, wherein the ethyl acetate or diethyl ether in step (c) is added before the graphene oxide precipitates.

23. The method of claim 20, further comprising transferring the film onto a substrate after step (c).

24.-25. (canceled)

26. A large-area graphene oxide film manufactured by the method of claim 20.
